(19) United States
(12) Patent Application Publication
(10) Pub. No.: US 2016/0004331 A1
(43) Pub. Date: Jan. 7, 2016

(54) METHOD AND DEVICE FOR SIMULATING MOUSE OPERATION BY ROCKER AND ELECTRONIC EQUIPMENT

(71) Applicant: SUZHOU SNAIL TECHNOLOGY DIGITAL CO.,LTD, Suzhou (CN)

(72) Inventors: Guanshui Long, Shenzhen (CN); Xiaohui Lu, Shenzhen (CN); Ruomei Peng, Shenzhen (CN); Zhiqiang He, Shenzhen (CN); Li Zhang, Shenzhen (CN)

(21) Appl. No.: 14/322,740

(22) Filed: Jul. 2, 2014

(51) Int. Cl. G06F 3/0338; G06F 3/0354

(52) U.S. Cl. CPC G06F 3/0338; G06F 3/0354

(57) ABSTRACT

The embodiments of the present invention disclose a method for simulating mouse actions with a joystick, comprising: acquiring movement parameters input during movement of a joystick; computing and obtaining the target position of a mouse pointer on the interface of a terminal unit according to the movement parameters; and, displaying the mouse pointer at the position indicated by the target position. Moreover, a device and an electronic equipment for simulating mouse actions with a joystick are also disclosed by the embodiments of the present invention. With the present invention, the accuracy and precision of mouse operations can be improved.

### I. TECHNICAL FIELD

The present invention relates to the field of electronics, in particular to a method, a device, and an electronic equipment for simulating mouse actions with a joystick.

### II. TECHNICAL BACKGROUND

Mouse is an abbreviated term of a computer input device, and is divided into wired mouse and wireless mouse. Mouse is also an indicator for positioning horizontal and vertical coordinates in a computer display system, and is used to simplify computer operations and replace complex keyboard operations. Mouse can be categorized by its working principle into mechanical mouse and optical mouse. A mechanical mouse mainly comprises a ball, rolls, and grating signal sensors. When a mouse is dragged, the ball will be driven to rotate, the rollers will be driven to rotate by the ball, and the grating signal sensors mounted on the ends of the rollers will generate photoelectric pulse signals, which reflect the displacement of the mouse in vertical and horizontal directions; then, the photoelectric pulse signals are processed and converted by a computer program, so as to control the movement of cursor arrow on a display screen.

In the prior art, most terminal units that employs a large display screen accomplish corresponding operations on the graphical interface by means of a mouse. However, as an external mouse is required to carry out mouse-based operations, it will be difficult to achieve accurate positioning of the arrow of the mouse, thus the operations and control will be very inconvenient.

### III. CONTENTS OF THE INVENTION

A technical problem to be solved by the embodiments of the present invention is to provide a method, a device, and an electronic equipment for simulating mouse actions with a joystick, which can solve the problem that the operation of external mouse is inconvenient in the prior art.

To solve the technical problem described above, in the embodiments of the present invention, a method for simulating mouse actions with a joystick is provided, comprising:

acquiring movement parameters input during movement of a joystick;

computing and obtaining the target position of a mouse pointer on the interface of a terminal unit, according to the movement parameters;

displaying the mouse pointer at the position indicated by the target position.

Accordingly, in the embodiments of the present invention, a device for simulating mouse actions with a joystick is provided, comprising:

an acquiring module, designed to acquire movement parameters input during movement of a joystick;

a computing module, designed to compute and obtain the target position of a mouse pointer on the interface of a terminal unit, according to the movement parameters;

a display module, designed to display the mouse pointer at the position indicated by the target position.

The present invention further provides an electronic equipment, comprising the device described above.

The embodiments of the present invention can achieve the following beneficial effects:

The input movement parameters are acquired during movement of the joystick; the target position of the mouse pointer on the interface of a terminal unit is calculated and obtained according to the movement parameters, and then the mouse pointer is displayed at the position indicated by the target position. Thus, unlike the prior art, there is no need to use an external mouse to control the mouse pointer on the interface of a terminal unit; as a result, the hardware cost is reduced, and the operations are more accurate and easier.

### IV. DESCRIPTION OF DRAWINGS

For better understanding of the technical scheme in the embodiments of the present invention or in the prior art, hereunder the accompanying drawings used in the description of the embodiments or the prior art will be introduced briefly. Apparently, the accompanying drawings described below only illustrate some embodiments of the present invention. The person skilled in the art can obtain drawings of other embodiments on the basis of these drawings without creative labor.

FIG. 1 is a schematic diagram of a structure of the device for simulating mouse actions with a joystick according to an embodiment of the present invention;

FIG. 2 is a schematic diagram of another structure of the device for simulating mouse actions with a joystick according to an embodiment of the present invention;

FIG. 3 is a schematic structural diagram of the computing module shown in FIG. 2;

FIG. 4 is a schematic structural diagram of the display module shown in FIG. 2;

FIG. 5 is a flow chart of the method for simulating mouse actions with a joystick according to an embodiment of the present invention;

FIG. 6 is another flow chart of the method for simulating mouse actions with a joystick according to an embodiment of the present invention.

### V. EMBODIMENTS

Hereunder the technical scheme of the present invention will be detailed clearly and completely with reference to the accompanying drawings. Apparently, the described embodiments are only some embodiments of the present invention, but not all embodiments of the present invention. Other embodiments obtained by the person skilled in the art without creative labor, on the basis of the embodiments provided here, shall be deemed as falling into the protection scope of the present invention.

Please see FIG. 1, which is a schematic diagram of a structure of the device for simulating mouse actions with a joystick (hereafter referred to as device 1) according to an embodiment of the present invention. The device 1 comprises:

an acquiring module 11, designed to acquire movement parameters input during movement of a joystick;

specifically, the movement parameters of the joystick include movement amplitude, movement direction, and movement speed; the joystick is usually a four-way joystick, which can move in horizontal and vertical directions, and the acquiring module acquires the movement parameters input during movement of the joystick;

a computing module 12, designed to compute and obtain the target position of a mouse pointer on the interface of a terminal unit, according to the movement parameters;

specifically, the computing module 12 obtains the offset of the mouse pointer on the interface of the terminal unit according to the movement parameters of the joystick, and then obtains the target position of the mouse pointer on the interface of the terminal unit according to the initial position and offset of the mouse pointer; the computing method is as follows: suppose the initial position of the mouse pointer is (x0, y0) and the offset is m, the target position of the mouse pointer will be (x0+m, y0) if the offset is in X direction, or it will be (x0, y0+m) if the offset is in Y direction, for example, suppose the initial position of the mouse pointer is at coordinates (0, 0) on the interface of the terminal unit and the offset of the joystick is 100 pixels in the positive X axis direction, the target position of the mouse pointer will be at (100, 0);

a display module 13, designed to display the mouse pointer at the position indicated by the target position;

specifically, the display module 13 displays the mouse pointer at the coordinates indicated by the target position, according to the target position obtained by the computing module.

In the embodiment of the present invention, the target position of the mouse pointer on the interface of a terminal unit is computed and obtained according to the movement parameters, and then the mouse pointer is displayed at the position indicated by the target position, no that the movement of the mouse pointer on the interface of the terminal unit is simulated with the joystick. Thus, unlike the prior art, there is no need to use external mouse to control the mouse pointer on the interface of a terminal unit; as a result, the hardware cost is reduced, and the operations are more accurate and easier.

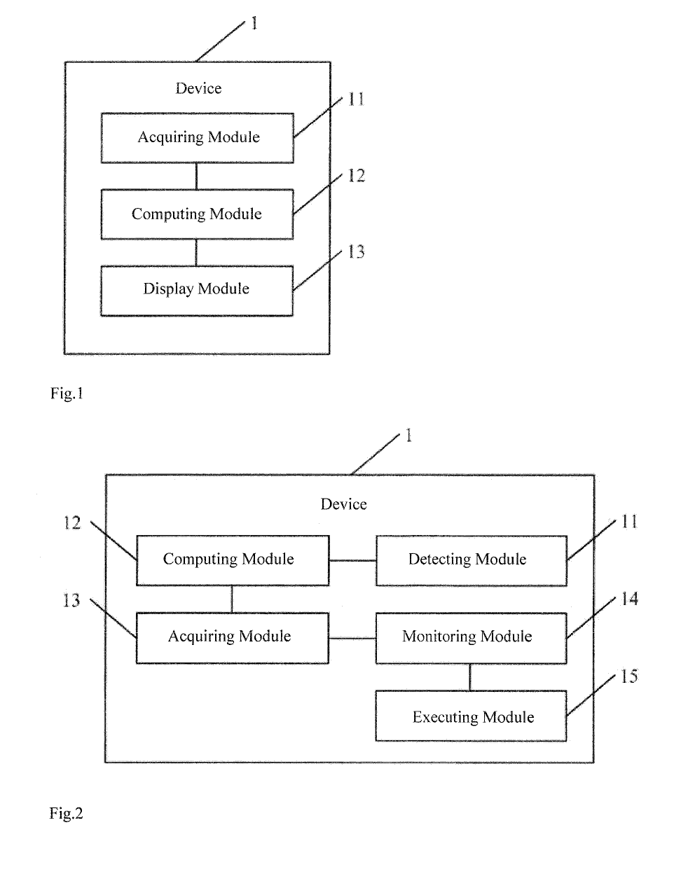

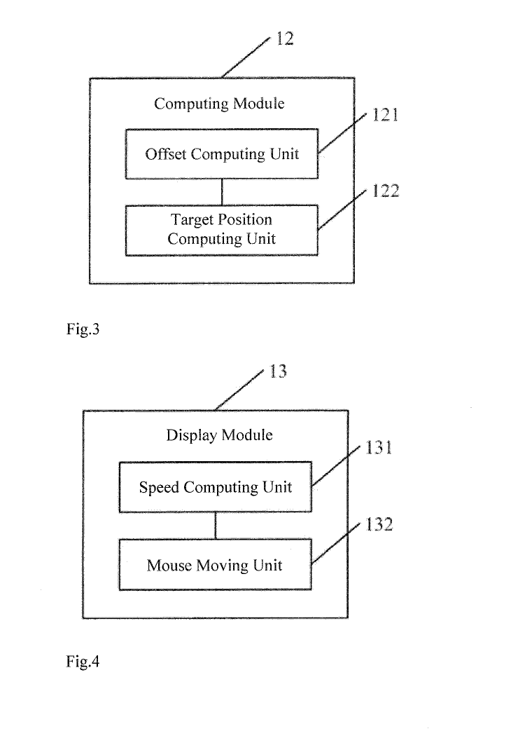

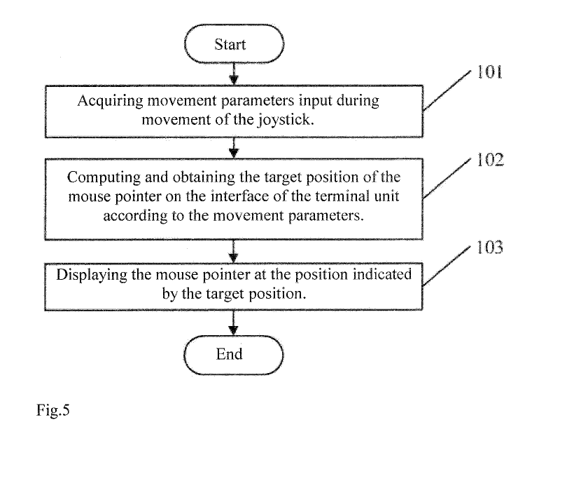

Please see FIGS. 2-4, which are schematic diagram of another structure of the device for simulating mouse actions with a joystick in the present invention. The device comprises acquiring module 11, computing module 12, and display module 13, and further comprises:

a monitoring module 14, designed to monitor whether a target button is pressed, and, if the target button is pressed, generate a touch screen event at the current position of the mouse pointer;

specifically, the target button is used to simulate the left button or right button of the mouse, hereunder the target button is described to simulate left mouse button, and the principle for simulating the right mouse button is identical; the monitoring module 14 monitors whether a target button is pressed, and, if a target button is pressed, it will generate a touch screen event at the current position of the mouse pointer; through the configuration of the target buttons and the joystick, touch screen operations can be realized on non-touch screen equipment, in addition, the operations of the joystick and buttons are more accurate than conventional touch screen operations;

an executing module 15, designed to execute the operation corresponding to the touch screen event, wherein, the target button is used to simulate the left button or right button of a mouse;

specifically, when the executing module 15 receives a touch screen event sent by the monitoring module, it will execute the corresponding operation according to the position where the touch screen event happens and the type of the touch screen event,

wherein, the computing module 12 comprises:

an offset computing unit 121, designed to compute and obtain the offset according to the movement amplitude of the joystick;

specifically, the offset computing unit 121 obtains the corresponding offset of mouse pointer on the interface of the terminal unit according to the movement amplitude of the joystick, wherein, the movement amplitude of the joystick is proportional to the offset, which is to say, the higher the movement amplitude is, the greater the offset will be, and the lower the movement amplitude is, the smaller the offset will be; the movement direction of the joystick can be X direction or Y direction: when the joystick moves in X direction, the offset computing unit 121 will compute and obtain the offset of the mouse pointer in X direction on the interface of the terminal unit according to the movement amplitude of the joystick; when the joystick moves in Y direction, the offset computing unit 121 will compute and obtain the offset of the mouse pointer in Y direction on the interface of the terminal unit according to the movement amplitude of the joystick;

a target position computing unit 122, designed to compute and obtain the target position of the mouse pointer on the interface of the terminal unit, according to the initial position and offset of the mouse pointer;

specifically, the target position computing unit 122 obtains the target position of the mouse pointer on the interface of the terminal unit by adding the offset in the corresponding direction to the initial position (x0, y0) of the mouse pointer.

The display module 13 comprises:

a speed computing unit 131, designed to compute and obtain the movement speed of the mouse pointer according to the movement speed of the joystick;

specifically, the speed computing unit 131 obtains the corresponding movement speed of the mouse pointer on the interface of the terminal unit according to the movement speed of the joystick, wherein, the movement speed of the joystick is proportional to the movement speed of the mouse pointer, which is to say, the higher the movement speed of the joystick is, the higher the movement speed of the mouse pointer on the interface of the terminal unit will be, and the lower the movement speed of the joystick is, the lower the movement speed of the mouse pointer will be; the movement direction of the joystick can be X direction or Y direction: if the joystick moves in X direction, the mouse pointer will move in X direction accordingly; if the joystick moves in Y direction, the mouse pointer will move in Y direction accordingly;

a mouse moving unit 132, designed to move the mouse pointer from the initial position to the target position, according to the computed movement speed of the mouse.

In the embodiment of the present invention, the target position of the mouse pointer on the interface of a terminal unit is computed and obtained according to the movement parameters, and then the mouse pointer is displayed at the position indicated by the target position, so that the movement of the mouse pointer on the interface of the terminal unit is simulated with the joystick. Thus, unlike the prior art, there is no need to use an external mouse to control the mouse pointer on the interface of a terminal unit; as a result, the hardware cost is reduced, and the operations are more accurate and easier.

Please see FIG. 5, which is a flow chart of the method for simulating mouse actions with a joystick in the present invention. The method comprises:

step 101: acquiring movement parameters input during movement of a joystick;

step 102: computing and obtaining the target position of the mouse pointer on the interface of a terminal unit, according to the movement parameters;

step 103: displaying the mouse pointer at the position indicated by the target position.

In the embodiment of the present invention, the target position of the mouse pointer on the interface of a terminal unit is computed and obtained according to the movement parameters, and then the mouse pointer is displayed at the position indicated by the target position, so that the movement of the mouse pointer on the interface of the terminal unit is simulated with the joystick. Thus, unlike the prior art, there is no need to use an external mouse to control the mouse pointer on the interface of a terminal unit; as a result, the hardware cost is reduced, and the operations are more accurate and easier.

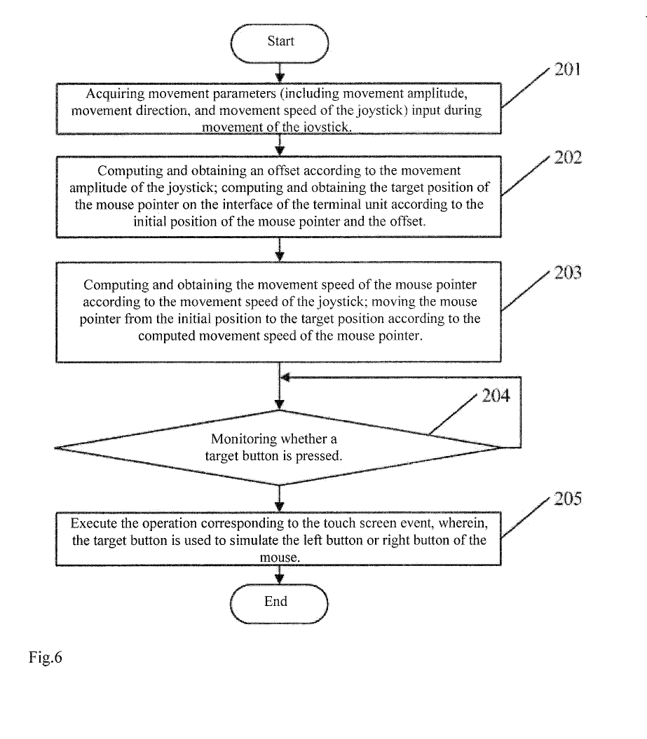

Please see FIG. 6, which is another flow chart of the method for simulating mouse actions with a joystick in the present invention. The method comprises:

step 201: acquiring movement parameters of a joystick (including movement amplitude, movement direction, and movement speed of the joystick) input during movement of the joystick;

step 202: computing and obtaining the offset according to the movement amplitude of the joystick; computing and obtaining the target position of the mouse pointer on the interface of a terminal unit according to the initial position of the mouse pointer and the offset;

step 203: computing and obtaining the movement speed of the mouse pointer according to the movement speed of the joystick; moving the mouse pointer from the initial position to the target position according to the computed movement speed of the mouse pointer;

step 204: monitoring whether the target button is pressed;

specifically, if the target button is pressed, step 205 will be executed: otherwise the monitoring will be continued;

step 205: executing the operation corresponding to the touch screen event, wherein, the target button is used to simulate the left button or right button of the mouse.

In the embodiment of the present invention, the target position of the mouse pointer on the interface of a terminal unit is computed and obtained according to the movement parameters, and then the mouse pointer is displayed at the position indicated by the target position, so that the movement of the mouse pointer on the interface of the terminal unit is simulated with the joystick. Thus, unlike the prior art, there is no need to use an external mouse to control the mouse pointer on the interface of a terminal unit; as a result, the hardware cost is reduced, and the operations are more accurate and easier.

The person skilled in the art can understand that the process flows of the methods in the above embodiments can be implemented in part or in entirety by utilizing a computer program to instruct relevant hardware, the computer program can be stored in a computer readable storage medium, and the program can comprise the process flows of the embodiments of the methods described above when it is executed, wherein, the storage medium can be a magnetic disk, optical disk, Read-Only Memory (ROM), or Random Access Memory (RAM), etc.

While the present invention is described and disclosed above in some preferred embodiments, the present invention is not limited to those embodiments. The person skilled in the art can appreciate that any equivalent modification or variation that can implement the process flows in the embodiments described above in part or in entirety on the basis of the claims of the present invention is deemed as falling into the protection scope of the present invention.

1-11. (canceled)

12. A method for simulating mouse actions with a joystick, comprising:
acquiring movement parameters input during movement of a joystick;
computing and obtaining the target position of a mouse pointer on the interface of a terminal unit according to the movement parameters;
displaying the mouse pointer at the position indicated by the target position.

13. The method according to claim 12, further comprising the following step after the step of displaying the mouse pointer at the position indicated by the target position:
monitoring whether a target button is pressed, and, if the target button is pressed, generating a touch screen event at the current position of the mouse pointer;
executing the operation corresponding to the touch screen event, wherein, the target button is used to simulate the left button or right button of the mouse.

14. The method according to claim 13, wherein, the movement parameters of the joystick include movement amplitude, movement direction, and movement speed of the joystick, and the step of acquiring the movement parameters input during movement of the joystick comprises:
during the movement of joystick, acquiring movement parameters of the joystick, which includes movement amplitude, movement direction, and movement speed of the joystick.

15. The method according to claim 14, wherein, the step of computing and obtaining the target position of the mouse pointer on the interface of the terminal unit according to the movement parameters comprises:
computing and obtaining the offset according to the movement amplitude of the joystick;
computing and obtaining the target position of the mouse pointer on the interface of a terminal unit, according to the initial position of the mouse pointer and the offset.

16. The method according to claim 15, wherein, the step of displaying the mouse pointer at the position indicated by the target position comprises:
computing and obtaining the movement speed of the mouse pointer according to the movement speed of the joystick;
moving the mouse pointer from the initial position to the target position, according to the movement speed of the computed mouse pointer.

17. A device for simulating mouse actions with a joystick, comprising:
an acquiring module, designed to acquire movement parameters input during movement of a joystick;
a computing module, designed to compute and obtain the target position of a mouse pointer on the interface of a terminal unit, according to the movement parameters;
a display module, designed to display the mouse pointer at the position indicated by the target position.

18. The device according to claim 17, further comprising:
a monitoring module, designed to monitor whether the target button is pressed, and, if a target button is pressed, generate a touch screen event at the current position of the mouse pointer;
an executing module, designed to execute the operation corresponding to the touch screen event, wherein, the target button is used to simulate the left button or right button of a mouse.

19. The device according to claim 18, wherein, the acquiring module is designed for:
during movement of joystick, acquiring input movement parameters of the joystick, which include movement amplitude, movement direction, and movement speed of the joystick.

20. The device according to claim 19, wherein, the computing module comprises:
an offset computing unit, designed to compute and obtain the offset according to the movement amplitude of the joystick;
a target position computing unit, designed to compute and obtain the target position of the mouse pointer on the interface of the terminal unit, according to the initial position and offset of the mouse pointer.

21. The device according to claim 20, wherein, the display module comprises:
a speed computing unit, designed to compute and obtain the movement speed of the mouse pointer according to the movement speed of the joystick;
a mouse moving unit, designed to move the mouse pointer from the initial position to the target position, according to the computed movement speed of the mouse pointer.

22. An electronic equipment, comprising the device for simulating mouse actions with a joystick according to claim 17.

23. An electronic equipment, comprising the device for simulating mouse actions with a joystick according to claim 18.

24. An electronic equipment, comprising the device for simulating mouse actions with a joystick according to claim 19.

25. An electronic equipment, comprising the device for simulating mouse actions with a joystick according to claim 20.

26. An electronic equipment, comprising the device for simulating mouse actions with a joystick according to claim 21.
